(19) United States
(12) Patent Application Publication
(10) Pub. No.: US 2010/0213797 A1
(43) Pub. Date: Aug. 26, 2010

(54) METHOD FOR CONNECTING PARTS OF A MULTIPLE-PART ROTOR CARRIER, AND ROTOR CARRIER OF AN ELECTRICAL MACHINE

(76) Inventors: Rainer Stoeckl, Schwieberdingen (DE); Anja Hofmeister, Renningen (DE); Miro Bekavac, Korntal-Muenchingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/682,395

(22) PCT Filed: Sep. 29, 2008
(86) PCT No.: PCT/EP2008/063020

§ 371 Date: Apr. 9, 2010

(30) Foreign Application Priority Data
Oct. 12, 2007 (DE) 102007049149.4

(51) Int. Cl. H02K 5/04; H02K 15/14

(52) U.S. Cl. 310/418; 29/596

(57) ABSTRACT

The invention relates to a method for connecting parts of a multiple-part rotor carrier of an electric engine, the rotor carrier having a rotor hub as one part, and a carrier part arranged on the rotor hub, as another part, the rotor hub and carrier part being interconnected in a rotationally fixed manner by means of a connection process. According to the invention, the connection process consists of a penetrating joining method. The invention also relates to a multiple-part rotor carrier of an electric engine, having a rotor hub as one part, and a carrier part arranged on the rotor hub, as another part. The rotor hub and carrier part are interconnected in a rotationally fixed manner on at least one connection point. According to the invention, a penetrating joint is provided as the connection point.

The invention relates to a method for connecting parts of a multiple-part rotor carrier of an electrical machine as generically defined by the preamble to claim 1, and to a multiple-part rotor carrier of that kind.

### PRIOR ART

In the manufacture of rotors for electrical machines, single-part rotor carriers made by reshaping or casting are widely used at present, but because of their technical disadvantages and their possible commercial disadvantages, depending on the field in which they are used, they are increasingly being replaced by multiple-part rotor carriers. These multiple-part rotor carriers may for instance a rotor hub, made approximately in cup form, and a carrier part, mounted on the rotor hub, in the form of a cylindrical tube portion, so that the rotor hub and the carrier part can be made separately, and the carrier part can be connected electrically in its complete axial length, for instance, without having to take curved radii into account at the transition to the rotor hub. Moreover, the rotor hub can be axially displaced relative to the carrier part or disposed inside the carrier part within wide limits, so that there are considerable advantages and freedom in terms of installation space in the design of the arrangement. The parts of multiple-part rotor carriers, such as the rotor hub and the carrier part, must be connected to one another in a manner fixed against relative rotation in order to form the rotor carrier, or in other words must be connected in such a way that the parts to be connected do not execute any relative motion to one another. In the prior art, because of the heat input that welding unavoidably entails, thermally-caused warping of one or more of the parts can occur in unfavorable cases and can lead to problems of imprecision and/or imbalance and these parts must be complicatedly remachined, or if unmachined, they can lose some quality. Moreover, these welding operations are relatively complicated overall.

### DISCLOSURE OF THE INVENTION

It is the object of the invention to furnish a method for connecting parts of a multiple-part rotor carrier of an electrical machine that overcomes the aforementioned disadvantages and that makes economical production, optimized in terms of manufacture, of multiple-part rotor carriers possible.

To that end, a method for connecting parts of a multiple-part rotor carrier of an electrical machine is proposed in which the rotor carrier has a rotor hub as one part and a carrier part disposed on the rotor hub as another part, and the rotor hub and carrier part are connected to one another in a manner fixed against relative rotation by means of a connection operation. It is provided that penetration joining is performed as the connection operation. The individual parts of the multiple-part rotor carrier are produced by reshaping, casting, or machine-cutting from solid material, in a manner that is familiar from the prior art. The parts are limited to parts that can be produced simply and economically in these methods, in particular in the case of large-sized electrical machines of the kind used for instance in electric and hybrid drives. These parts are machined in the manner required for the purpose and are then connected to one another in a manner fixed against relative rotation by a connection operation. As the connection operation, penetration joining is performed, which in the prior art, as a time-tested connection technique for metal sheets, is also known as pressure joining, clinching or Tox clinching. The penetration joining does not input any heat into the parts to be connected, so that thermal warping of the parts is prevented. Moreover, the penetration joining can be performed without introducing additional materials, which is advantageous in terms of both economy and quality. Depending on the requirements for precision and tolerances made of the rotor carrier, the penetration joining can be followed by further machining, for instance in the form of low-voltage annealing and/or further cutting, to the desired final geometry of the rotor carrier. The term “penetration joining” is understood to mean that material of one part is introduced into regions of the other part, in particular by pressing with suitable pressing dies, such that there is a force- and form-locking connection in the joining region of the parts to be connected. The exemplary embodiments illustrate further details.

In a further method embodiment, the penetration joining is done in the solid material of the parts. Before the connection operation, in the joining region the parts are accordingly not machined for the sake of making the connection; instead, the penetration joining leads to a force lock and form lock from the solid material of the parts, or in other words in particular without predrilling, prepunching or similar premachining pretreatment of at least one of the two parts to be connected. It is advantageous in this respect that the penetration joining is performed as an especially inexpensive, economical connection operation, since, as described, a pretreatment in the joining region of the parts to be connected is dispensed with.

In another method embodiment, before the penetration joining, at least one of the parts is preprocessed in the joining region of the connection point to be made, in particular being preperforated and/or reshaped. Particularly with large-scale parts or those with great material thickness, preprocessing the joining region may be desirable, to make it possible to avoid undesirably high mechanical loads on the joining region, especially with very great material thicknesses, in which penetration joining of the material with the desired precision is no longer possible. By means of the preprocessing, such as preperforation, prepunching or reshaping, the penetration of the material of the one part by material of the other part is made easier, since the pressing die that performs the connection operation no longer has to reshape a plurality of parts through their full material thickness. On the one hand, the pressing force that has to be exerted is reduced, and on the other, precisely with great material thicknesses, better precision of the connection operation can be achieved.

Furthermore, a multiple-part rotor carrier of an electrical machine is proposed which has a rotor hub as one part and a carrier part disposed on the rotor hub as another part, and the rotor hub and the carrier part are connected to one another in a manner fixed against relative rotation by means of a connection operation. In this respect it is provided that as the connection point, a penetration joint is provided. As described above, the penetration joint is made in the course of the cold forming as a material penetration of the material of the one part by material of the other part by exertion of force by means of a pressing die. An unnecessary heat input and in particular thermal warping of the parts to be connected is advantageously avoided as a result.

In a further embodiment of the rotor carrier, the penetration joint is made from the solid material of the parts. Particularly if the material thickness of one or more parts is not especially great, a connection that is fixed against relative rotation can thus be made inexpensively without major manufacturing complexity or expense.

In another embodiment, the at least one part has a shaped or reshaped feature into which as a result of the penetration joining material of the other part has been forced. Even parts that are thick materially can be economically joined to one another in the course of the penetration joining, without the rotor carrier experiencing an unwanted heat input as a result of what until now was the required welding of the parts. By means of the shaped or reshaped feature, a form-locking overlapping or folding over of material of one part over material of the other can for instance be attained, so that a very particularly solid, form-locking connection between the parts to be connected can be achieved.

Further advantageous embodiments will become apparent from the dependent claims and combinations thereof.

The invention will be described in further detail on the basis of exemplary embodiments, but without being limited to them.

### BRIEF DESCRIPTION OF THE DRAWINGS

Shown are:

FIG. 1, a two-part rotor carrier with a rotor hub and a carrier part disposed thereon, in longitudinal section;

FIG. 2, the same rotor carrier, in a perspective view;

FIG. 3, penetration joining from the solid material;

FIG. 4, penetration joining from the solid material without cantilevering;

FIG. 5, penetration joining with one preperforated part; and

FIG. 6, the penetration joining with two preperforated parts, of which one has been reshaped beforehand.

### EMBODIMENT(S) OF THE INVENTION

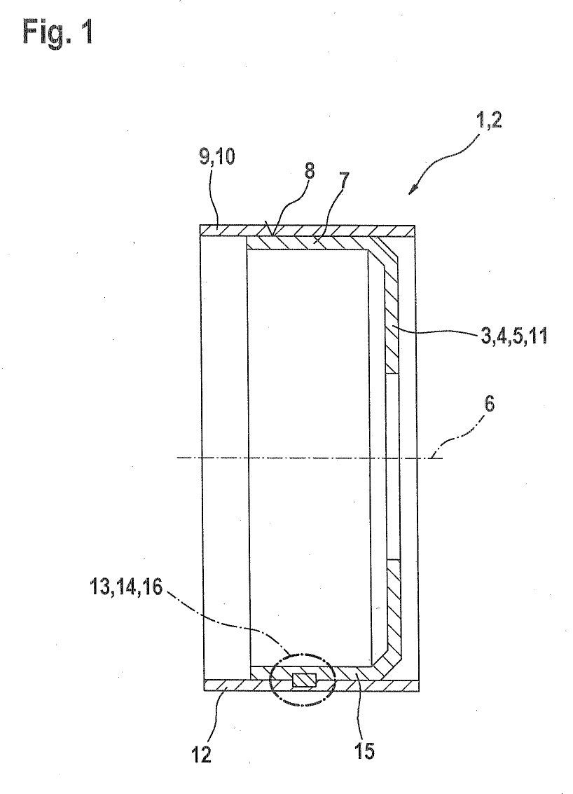

FIG. 1 shows a rotor carrier 1, namely a two-part rotor carrier 2. It comprises a rotor hub 3, which is embodied substantially in the form of a cup 4, and the cup 4 is a body of rotation 5 that is embodied rotationally symmetrically to an axis 6 of rotation of the rotor carrier 1 and has a side wall 7, essentially parallel to the axis 6 of rotation, on the outside 8 of which a carrier part 9 of the rotor carrier 1 is mounted for embodying the two-part rotor carrier 2, and the carrier part 9 is embodied as a tubular portion 10. The rotor hub 3 here forms the one part 11 of the rotor carrier 1, while the carrier part 9 forms the other part 12 of the rotor carrier 1. The one part 11 is connected to the other part 12 via at least one connection point 13, which is embodied as a penetration joint 14. In this process, material 15 of the one part 11 is introduced into the other part 12, so that the other part 12 is penetrated by material 15 of the one part 11. The result is a connection 16 that is fixed against relative rotation, so that upon rotation of the rotor hub 3, the carrier part 9 is slaved to it without relative motion with respect to the rotor hub 3. It is understood that as a rule, a number of connection points 13 ranging from more than one to many is provided, depending on the dimensioning of the rotor carrier 1 and in particular on its diameter and weight, and also depending on the forces and torques to be transmitted. The connection point 13 is shown here as a single connection point 13, merely as an example.

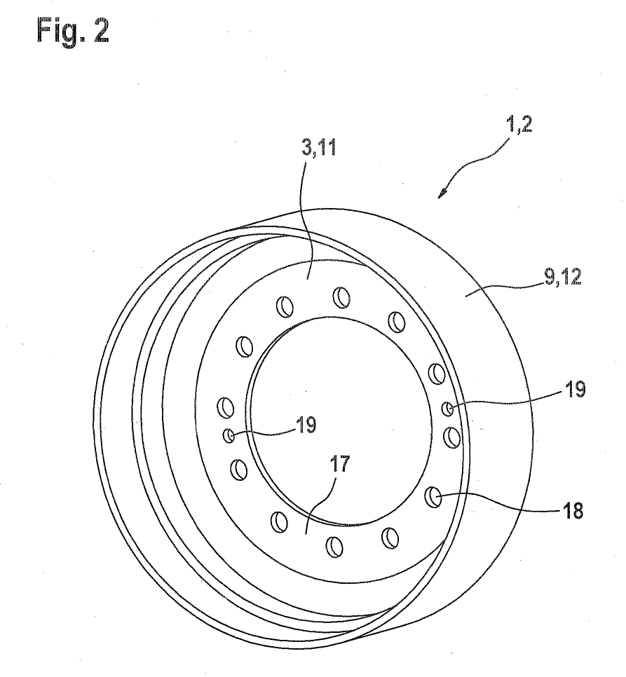

FIG. 2 shows the rotor carrier 1, namely the two-part rotor carrier 2 with the rotor hub 3 as the one part 11 and with the other part 12, namely the carrier part 9, connected to the one part in a manner fixed against relative rotation. For mounting the rotor carrier 1 on a further device, not shown here, such as a drive train or power takeoff train, the rotor hub 3 has assembly recesses 18 on its cup bottom 17, and these recesses may in particular be combined with rotary alignment means 19 and/or centering bores for the sake of positionally correct alignment.

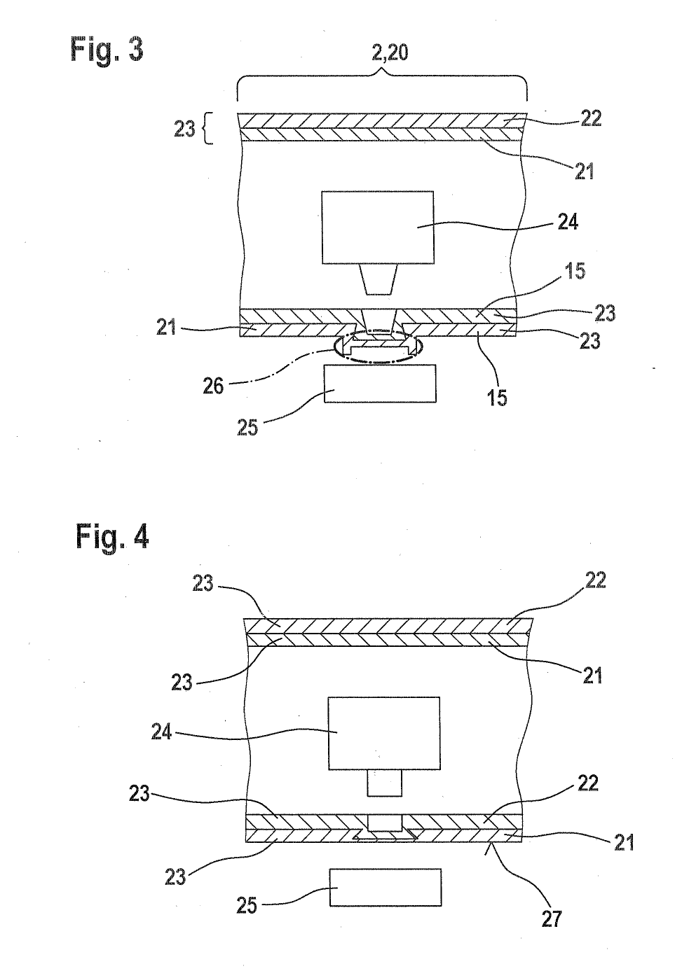

FIG. 3 shows the method of penetration joining on a portion 20 of the two-part rotor carrier 2, namely a side wall portion 21 of the rotor hub 3, which portion here is shown as a plane portion for the sake of simplicity, and a tubular wall portion 22 of the carrier part 9 embodied as a tubular portion 10. It is understood that the penetration joining may also be performed in a different direction from what is shown here. The penetration joining is performed here without preprocessing of the side wall portion 21 and/or of the tubular wall portion 22 from the solid Material 23 of both parts, such that a pressing die 24 strikes the solid material 23 of the superimposed side wall portions 21 and tubular wall portions 22 and reshapes them into a female die 25 adapted to it in shape. In the process, material 15 of the tubular wall portion 22 is introduced into material 15 of the side wall portion 21, and consequently the side wall portion 21 is penetrated by material 15 of the tubular wall portion 22. As a result of the embodiment of the female die 25, the result is that a cantilevered part 26 is developed on the female die side of the side wall portion 21.

FIG. 4 shows the penetration joining, again in terms of a side wall portion 21 shown as plane for the sake of simplicity and a tubular wall portion 22, but this time the embodiment of a cantilevered part 26 (FIG. 3) is to be avoided. Here the pressing die 24 is embodied as complementary to the female die 25, such that cantilevering caused by pressing of the solid material 23 of the tubular wall portion 22 through the solid material 23 of the side wall portion 21 does not take place, but instead reshaping of the side wall portion 21 past a female die side 27 oriented toward the side wall portion 21 does not take place. All that is reshaped here is the solid material 23 of the tubular wall portion 22, so that this portion is forced downward laterally into the solid material 23 of the side wall portion 21, but without causing deformation of the side wall portion 21 toward the female die 25. In this case, the female die 25 is preferably embodied as plane toward the female die side 27.

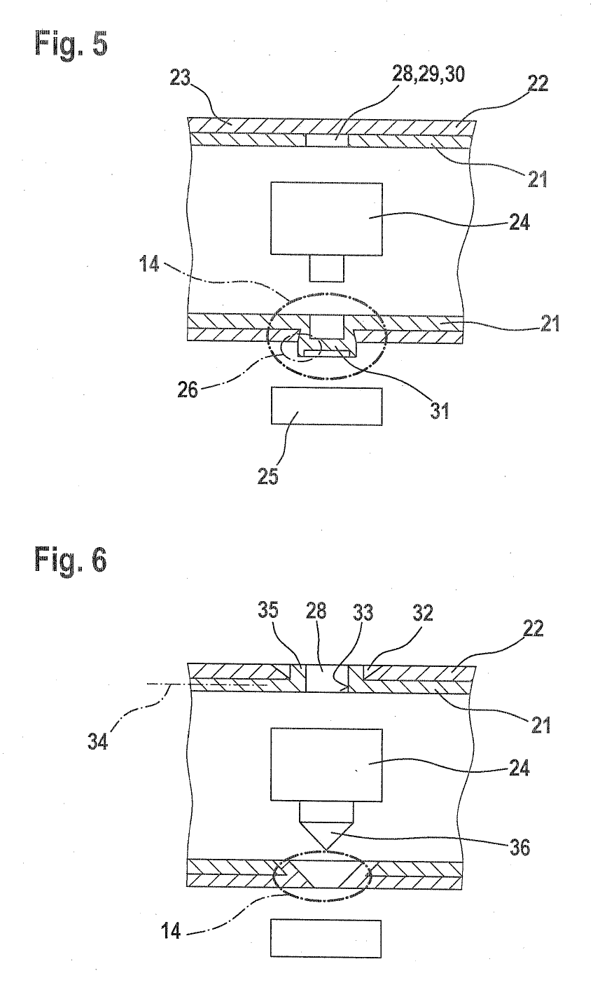

FIG. 5 shows the penetration joining with a side wall portion 21 that after preprocessing has a recess 28, such as a punched hole 29 or a bore 30. The tubular wall portion 22 resting on it is not preprocessed and in particular is not preperforated; with respect to the tubular wall portion 22, the penetration joining takes place in the solid material 23. In cooperation with the female die 25, the pressing die 24 forms a cup-shaped penetration 31 of the recess 28 made in the side wall portion 21, and the cantilevered part 26 fits around the recess 28 on the side toward the female die, thus attaining good solidity of the penetration joint 14 embodied in this way.

FIG. 6 shows the penetration joining with preprocessing of both parts, namely both the side wall portion 21 and the tubular wall portion 22. For this purpose, the tubular wall portion 22, like the side wall portion 21, has the recess 28, and the recess 28 in the tubular wall portion 22 is embodied as angular, such as a diagonally cut/countersunk tubular wall portion recess 32, in such a way that the tubular wall recess has a larger diameter on the side remote from the side wall portion 21 than on the side toward the side wall portion 21. The recess 28 in the side wall portion 21 is embodied as a side wall recess 33, in such a way that the side wall recess 33 has been made in the course of what is for instance a combined punching and reshaping operation, and has a cantilevered part, essentially perpendicular to the plane 34 of the side wall portion 21, in the direction of the tubular wall portion 22, specifically a cantilevered wall part 35 in particular projecting into the tubular wall recess 32. For further embodiment of the penetration joint 14, the pressing die 24 has a die mandrel 36, for instance embodied conically or frustoconically, which in the course of the pressing operation presses the cantilevered wall part 35 over onto the tubular wall recess 32 and in the process plastically durably deforms it, so that the cantilevered wall part 35 is pressed, for instance folded, in force- and form-locking fashion into the tubular wall recess 32.

1-6. (canceled)

7. A method for connecting parts of a multiple-part rotor carrier of an electrical machine, in which the rotor carrier has a rotor hub as one part and a carrier part disposed on the rotor hub as another part, the method having the step of connecting the rotor hub and carrier part to one another at a connection point in a manner fixed against relative rotation by means of a connection operation, wherein a penetration joining is performed as the connection operation.

8. The method as defined by claim 7, wherein the penetration joining is performed in solid material of the rotor hub and the carrier part.

9. The method as defined by claim 7, the method further having the step of preprocessing at least one of the rotor hub and the carrier part before the penetration joining, in particular by preperforating and/or reshaping, in a joining region of the connection point to be made.

10. The method as defined by claim 8, the method further having the step of preprocessing at least one of the rotor hub and the carrier part before the penetration joining, in particular by preperforating and/or reshaping, in a joining region of the connection point to be made.

11. A multiple-part rotor carrier of an electrical machine, which has a rotor hub as one part and a carrier part disposed on the rotor hub as an other part, the rotor hub and carrier part being connected to one another at a connection point in a manner fixed against relative rotation by means of a connection operation, wherein a penetration joint is provided as the connection point.

12. The rotor carrier as defined by claim 11, wherein the penetration joint is made from solid material of the rotor hub and of the carrier part.

13. The rotor carrier as defined by claim 11, wherein the at least one part has a preperforation or a reshaped feature into which material of the other part is forced by means of the penetration joining.

14. The rotor carrier as defined by claim 12, wherein the at least one part has a preperforation or a reshaped feature into which material of the other part is forced by means of the penetration joining.
